(19) United States
(12) Patent Application Publication
(10) Pub. No.: US 2013/0033144 A1
(43) Pub. Date: Feb. 7, 2013

(54) STIR-WELDED INDUCTION ROTOR

(71) Applicants: Timothy J. Alfermann, Noblesville, IN (US); John C. Morgante, Sterling Heights, MI (US)

(72) Inventors: Timothy J. Alfermann, Noblesville, IN (US); John C. Morgante, Sterling Heights, MI (US)

(73) Assignee: GM GLOBAL TECHNOLOGY OPERATIONS LLC, Detroit, MI (US)

(21) Appl. No.: 13/198,305

(22) Filed: Aug. 4, 2011

(51) Int. Cl. H02K 17/16; H02K 1/26

(52) U.S. Cl. 310/211; 310/216.004

(57) ABSTRACT

A stir-welded rotor includes a stack of laminations, where each of the laminations defines a plurality of spaced-apart slots arrayed on an outer circumference. A conductor bar may be registered with each of the spaced-apart slots of the stack of laminations, with each conductor bar including a first metal portion and a second metal portion having substantially dissimilar compositions.

### TECHNICAL FIELD

The present invention relates generally to a conductor bar design and configuration for use in a stir-welded induction rotor.

### BACKGROUND

An induction motor generally includes a central rotor surrounded by a stator. The stator includes windings through which an electrical current flows to produce a magnetic field. The magnetic field interacts with the rotor thereby causing the rotor to rotate.

Induction motors are relatively efficient in converting electrical energy into mechanical energy. Induction motors may, for example, find increasing application in hybrid powered vehicles that use a combination of an internal combustion engine and one or more electric motors to provide motive power. Electrical induction motors find application in other areas as well as providing supplemental motive power. For example, induction motors may provide power to a range of accessories that might otherwise be powered via hydraulic or other systems that are driven by an internal combustion engine. Additionally, induction motors may rotate at high rates of speed (e.g., over 10,000 revolutions per minute) depending on the application.

### SUMMARY

A stir-welded rotor includes a stack of laminations, wherein each of the laminations defines a plurality of spaced-apart slots arrayed on an outer circumference. A conductor bar may be registered with each of the spaced-apart slots of the stack of laminations, and may include a first metal portion and a second metal portion. In one configuration, the first and second metal portions may have dissimilar compositions. Furthermore, the first metal portion and a second metal portion may be substantially aligned on a radial axis, where the first metal portion is disposed radially inward of the second metal portion. In an embodiment, the second metal portion may have a generally circular cross-section that may promote enhanced electrical conductivity.

The stir-welded rotor may further include a first end ring that has a first inner end ring and a first outer end ring. Likewise, the rotor may include a second end ring that has a second inner end ring and a second outer end ring. Each conductor bar may have a first extremity that engages the first end ring between the first inner end ring and the first outer end ring and extends above the stack of laminations. Additionally, the conductor bar may have a second extremity that engages the second end ring between the second inner end ring and the second outer end ring and extends below the stack of laminations.

The rotor may also include a stir weld or plurality of stir welds that secure the first extremities of the respective conductor bars to the first inner end ring and the second outer end ring, and a second stir weld that secures the second extremities of the respective conductor bars to the second inner end ring and the second outer end ring.

In an embodiment, each of the laminations may include a neck portion that partially extends into each respective slot. As such, the neck portion may be configured to contact the conductor bar and restrain the conductor bar from radially outward movement. In another embodiment, the lamination may define both a first neck portion and a second neck portion that each may extend into the respective slots. The first neck portion may be configured to contact the first metal portion of the conductor bar and to restrain the first metal portion from radially outward movement, and likewise, the second neck portion may be configured to contact the second metal portion of the conductor bar and to restrain the second metal portion from radially outward movement. In an embodiment, the second metal portion may be in contact with the first metal portion, wherein the second metal portion restrains the first metal portion from radially outward movement.

The stir-welded rotor may further include an insulating coating disposed between the laminations and the respective conductor bars, the insulating coating may include a material that has a higher electrical resistivity than the conductor bar. In one configuration, the first metal portion and a second metal portion may be in electrical communication.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a stacked series of consolidated laminations, such as included with an induction motor rotor.

FIG. 2 is a schematic perspective view of an embodiment of a rotor assembly including an outer assembly ring and an inner assembly ring.

FIG. 3 is a schematic cross-sectional view of an embodiment of a rotor assembly, such as provided in FIG. 2.

FIG. 4 is a schematic perspective view of an embodiment of a rotor assembly being assembled and illustrates stacking of laminations onto an end ring with vertical conductor bars in place.

FIG. 5 is a schematic partial cross-sectional view of an embodiment of a rotor assembly during a stir weld joining procedure.

FIG. 6 is a schematic top view of a an embodiment of a rotor lamination.

FIG. 7 is an enlarged schematic view of a portion of a rotor lamination, such as from the area “FIG. 7” designated in FIG. 6, and includes a cross-sectional view of an embodiment of a plurality of conductor bars registered with slots provided in the lamination.

FIG. 8 is an enlarged schematic view of a portion of a rotor lamination, such as from the area “FIG. 7” designated in FIG. 6, and includes a cross-sectional view of a plurality of conductor bars registered with slots provided in the lamination.

FIG. 9 is an enlarged schematic view of a portion of a rotor lamination, such as from the area “FIG. 7” designated in FIG. 6, and includes a cross-sectional view of a plurality of conductor bars registered with slots provided in the lamination, and having an electrically insulating coating.

### DETAILED DESCRIPTION

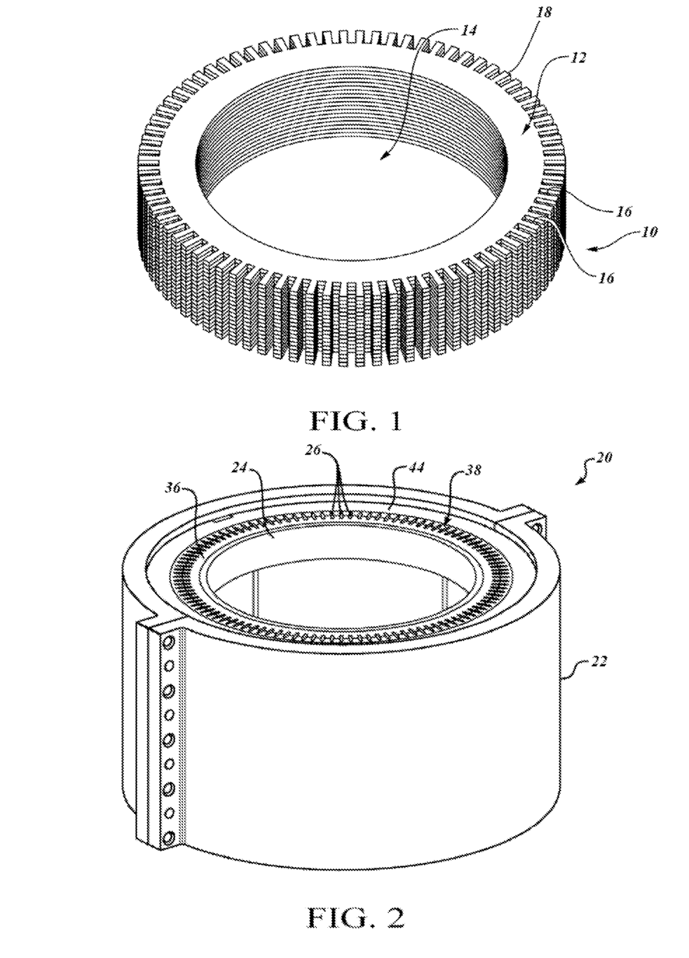

Referring to the drawings, wherein like reference numerals are used to identify like or identical components in the various views, FIG. 1 schematically illustrates an induction motor rotor stack 10. As illustrated in FIG. 1 the rotor stack 10 may include a plurality of individual laminations 12 that may, for example, be made from a steel or steel alloy material, and may be substantially identical to each other. Each lamination 12 may have a central circular hole 14 and may include a series of slots 16 or openings arrayed around an outer circumference 18, and are each configured to receive a conductive material. In some rotor configurations, a plurality of laminations 12 may be stacked and consolidated through a die casting process. In other configurations, the rotor stack 10 may be joined by stir-welding end rings to the stack 10, such as will be described below.

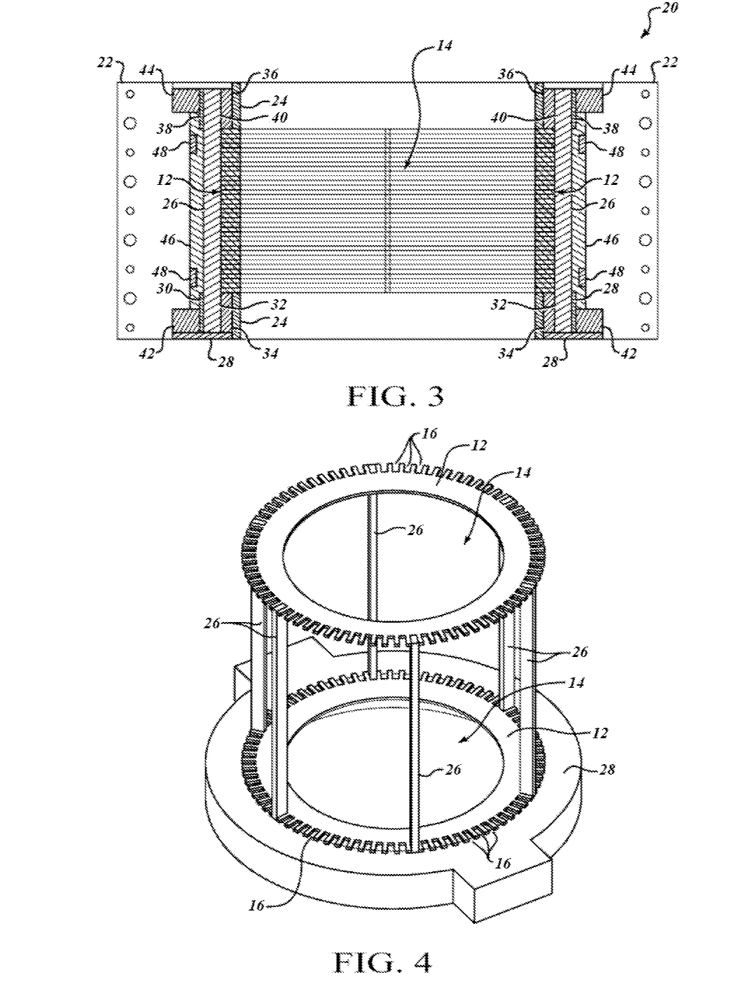

FIGS. 2-5 illustrate one particular manner of assembling an induction motor rotor through a stir-weld consolidation process. As shown in FIG. 2, the stir-weld assembly 20 may include an outer assembly ring 22 and an inner assembly ring 24. The inner assembly ring 24 and the outer assembly ring 22 may provide support for the rotor components during the stir weld process. As generally illustrated in FIG. 2, and shown with more clarity in the schematic cross-sectional view provided in FIG. 3, the inner assembly ring 24 may abut the central holes 14 of the respective laminations 12, while the outer assembly ring 22 may support the outer circumference 18.

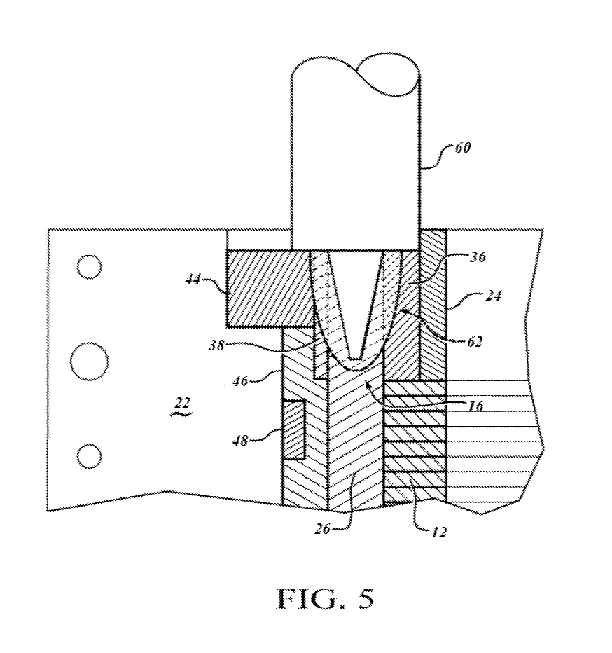

As further shown in the cross-sectional view of FIG. 3, and in the partially-assembled view of FIG. 4, the slots 16 provided in each lamination 12 may be regularly-spaced and may be configured to receive one or more vertically oriented conductor bars 26. Each conductor bar 26 may be supported in its vertical orientation on a lower separator plate 28. The conductor bars 26 may be at least partially wrapped in a thin electrically insulating material, such as NOMEX®, which is commercially available from the E. I. du Pont de Nemours and Company of Wilmington, Del. In an embodiment, the electrically insulating material may provide an electrical barrier between the conductor bar 26 and laminations 12, and may be operative to improve the electrical performance of the rotor.

As further illustrated in FIG. 3, a lower outer end ring 30, may extend around the outside of the array of conductor bars 26, and may register with the lower ends 32 of the conductor bars 26. As further illustrated in FIG. 3, a lower inner end ring 34 may be interposed between the lower ends 32 of conductor bars 26 and the inner assembly ring 24, and may similarly register with the lower ends 32 of the conductor bars 26 is. Thus, lower outer end ring 30 and the lower inner end ring 34 may together surround a portion of the vertical lower ends 32 of conductor bars 26.

Similar to the lower outer and inner end rings 30, 34, an upper inner end ring 36 and upper outer end ring 38 may be provided to surround a portion of the vertical upper ends 40 of the conductor bars 26. Accordingly, the conductor bars 26 are restrained from rotational and reciprocal motion. As a result, the laminations 12 are restrained from rotational motion relative to each other by the conductor bars 26 that are, in turn, restrained by the end rings 30, 34, 38, 36.

A lower weld ring 42 may subsequently be provided to extend around the lower outer end ring 30, and may rest upon the lower separator plate 28. Likewise, an upper weld ring 44 may be provided on the upper portion of the assembly, and on an opposing side of an outer weld ring 46 from the lower weld ring 42. The various weld rings 42, 44, 46 may be used to hold the components in rigid alignment during the stir welding process. Additionally, the weld rings 42, 44, 46 may be configured to supply a suitable coolant, such as, for example, through coolant channels 48, to minimize potential heat effects during stir welding. In an embodiment, the lower outer and inner end rings 30, 34, may be separate portions of the same respective ring. Similarly, the upper outer and inner end rings 38, 36 may also be portions of a single ring.

During stir welding, the halves of the outer assembly ring 22 are clamped or bolted together so that the above-described components of the stir weld assembly 20 are restrained from movement relative to each other. As schematically illustrated in FIG. 5, a stir weld tool 60 may then be used to weld both the upper end 40 and the lower end 32 of the assembly 20. Alternatively, other various single-pass or multi-pass welding techniques may be used to weld the upper and lower ends of the assembly.

As shown in FIG. 5, the stir weld tool 60 may impinge upon the various components, and substantially adhere adjacent materials to each other within the welding zone 62. In an embodiment, the welding zone 62 may encompass the upper weld ring 44, the upper ends 40 of the conductor bars 26 and the upper inner end ring 36. These components may be stir-welded for the entire upper ends and lower ends of the assembly 20 in a manner that may produce a substantially continuous stir weld. The stir-welded rotor assembly may then be subjected to machining to remove extraneous material and the weld rings 42, 44.

In high speed motor applications, an open slot 16 configuration of the rotor lamination 12 may permit the conductor bar 26 to creep in a radially outward direction relative to the steel rotor laminations 12. This tendency to creep may be further amplified if the conductor bar 26 is constructed from a softer material such as copper. To combat this creep-tendency, in one embodiment, the conductor bars 26 may be constructed from of a material with good electrical conductivity (i.e., low resistance) and adequate strength, such as aluminum 6101-T6. In other applications, however, higher conductivity materials may be desired, though the increased conductivity (i.e., lower resistance values) is typically associated with a lower material strength. When using such softer conductor materials, the end rings 30, 34, 38, 36 may sufficiently prevent any deformation of the end portions 40, 32 of the conductor bar 26, however, an open slot 16 (as shown in FIGS. 1 and 4) may not sufficiently restrain the central portion of the conductor bar 26 (i.e., the portion of the bar between the end rings 30, 34, 38, 36)

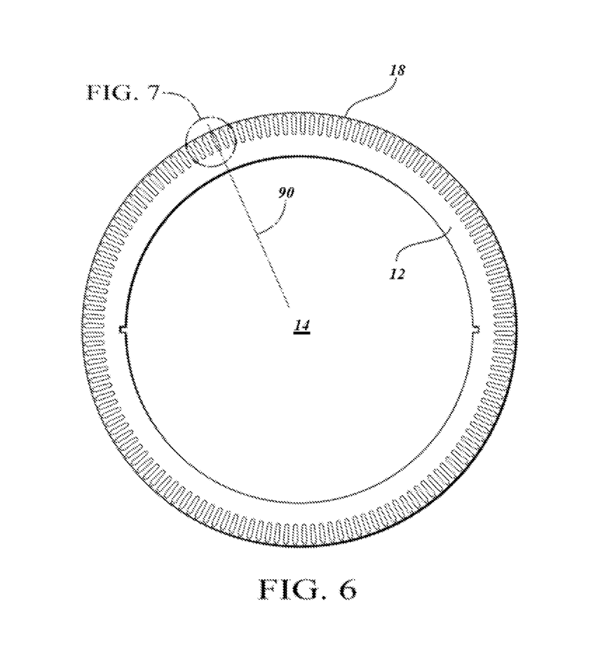

As generally illustrated in FIG. 6, and with more clarity in the enlarged schematic views provided in FIGS. 7-9, the design of the rotor laminations 12 may be adapted to radially restrain the conductor bar 26 from outward motion. For example, as shown in FIG. 7, each slot 16 may have a neck portion 70 that partially extends into the slot 16 and may contact the conductor bar 26 in such a manner to restrain the conductor bar 26 from radially outward movement. In one embodiment, the neck portion 70 may extend into the slot 16 (i.e., extend inward from a nominal slot width 74) a distance 72 that is great enough to sufficiently restrain the conductor bar 26, while still allowing a portion of the conductor bar 26 to be exposed along the outer circumference 18. As such, the neck portion 70 of each open slot 16 may provide an impediment or interference to any radial motion of the conductor bar 26, particularly when the rotor is spun at a high rate of speed.

As further illustrated in FIG. 7, in an embodiment, the conductor 26 bar may be constructed from two or more metal portions that have substantially dissimilar material compositions (e.g., metal portions 80 and 82). In one embodiment, the first metal portion 80 and a second metal portion 82 may be substantially aligned along a radial axis 90 of the laminations 12, with the first metal portion 80 (i.e., the inner metal portion 80) being disposed radially inward of the second metal portion 82 (i.e., the outer metal portion 82).

The material used for each metal portion 80, 82 of the conductor bar 26 may be chosen to optimize performance characteristics of the rotor. For example, in high-speed applications, the outer metal portion 82 material may be a high-strength metal that may discourage the conductor bar 26 from deforming out of the open slot 16. Conversely, the inner metal portion 80 material may be a material that has a higher relative conductance than the outward material 82, though may be softer and/or more susceptible to deformation under high rotational loading. For example, in such an embodiment, the inner metal portion 80 of the conductor bar 26 may be a copper material, where the outer metal portion 82 of the conductor bar 26 may be an aluminum material.

In another configuration, the materials may be chosen to efficiently operate in a high-frequency motor. As such, the outer metal portion 82 of the conductor bar 26 may have a higher conductance than the inner metal portion 80, since in high frequency applications, the current tends to be most densely located near the outer perimeter of the rotor. The inner metal portion 80 may then be a lower-cost material that has a relatively lower conductivity. For example, the outer metal portion 82 of the conductor bar 26 may be copper, while the inner metal portion 80 may be aluminum. Other designs and materials may be chosen to further optimize the performance of the rotor based on operating frequency, speed, and/or current density

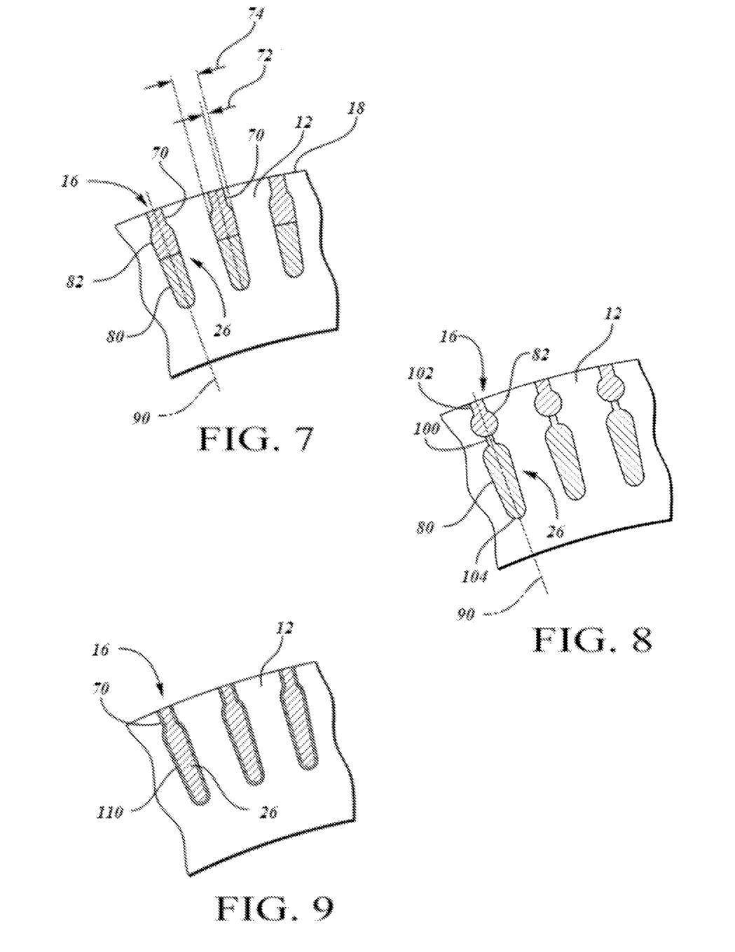

As schematically illustrated in FIG. 8, in another embodiment, each slot 16 may include multiple protrusions that are configured to create an interference that discourages radial motion of the conductor bar 26. For example, an inner neck portion 100 may extend into the open slot 16 at point between an outer neck portion 102 and the root 104 of the slot 16. The inner neck portion 100 may be configured to mate with the profile of the inner metal portion 80 of the conductor bar 26, and may be adapted to restrain the inner metal portion 80 from radially outward motion. Likewise, the outer neck portion 102 may be configured to mate with the profile of the outer metal portion 82 of the conductor bar 26, and may be adapted to restrain the outer metal portion 82 from radially outward motion.

In an embodiment, the cross-sectional profiles and material selection of the inner and outer metal portions 80, 82 of the conductor bar 26 may be respectively optimized to enhance the performance of the rotor. For example, as illustrated in FIG. 8, the outer metal portion 82 may have a generally circular cross-sectional profile and may be a material with a higher conductivity, such as copper. In such a configuration, the outer metal portion 82 may be suitably adapted to accommodate higher frequency operating currents, where the current flow tends to be concentrated near the outer circumference of the rotor, and near the surface of the conductor material. Correspondingly, the generally circular cross-sectional profile may increase the surface area of the conductor material disposed near the outer perimeter of the rotor.

As further illustrated in FIG. 8, the inner metal portion 80 of the conductor bar 26 may be adapted and/or optimized for lower frequency applications. Additionally, the inner metal portion 80 may be made from a slightly less-conductive material that may be acquired at a lower cost. For example, the inner metal portion 80 may be aluminum.

The inner and outer metal portions 80, 82 of the conductor bar 26 may be in electrical communication along their entire length, or at least along a substantial portion thereof. As such, electrical current may be free to pass through either or both of the materials as may be necessary for efficient operation. In one embodiment, the inner and outer metal portions 80, 82 of the conductor bar 26 may be fused together to facilitate the electrical communication. Such fusing may be accomplished through a suitable process, such as, for example, welding, soldering, brazing, cladding, and/or sintering.

As generally illustrated in FIG. 9, the conductor bar 26 (whether formed of a single material or multiple materials) may be electrically insulated and/or isolated from the surrounding rotor lamination 12 through an insulating coating 110. The insulating coating 110 may prevent or discourage current from flowing from the conductor bar 26 into the rotor stack 10. This isolation may serve to increase the efficiency and effectiveness of the rotor during operation by ensuring that any electrical current induced through a respective conductor bar 26 follows its intended path and does not get drawn away by a neighboring conductor bar or lost as a counter-productive circulating current within the rotor stack 10.

The insulating coating 110 may be a thin film of material that has a relatively high electrical resistivity as compared with the material of the conductor bar 26 or steel laminations 12. The coating 110 may at least coat the portion of the conductor bar 26 that lies within the slot 16 and abuts the laminations 12 to prevent electrical communication between the conductor bars 26 and the laminations 12. The coating 110 may be selected based on the expected operating temperature of the rotor, along with the expected maximum current flow/voltage through the conductor bar 26. Said another way, the coating material 110 should be selected so that it is capable of maintaining its dielectric properties throughout the full range of temperatures and stresses that the rotor is expected to experience. For example, a ceramic material may be used as the insulating coating 110 for higher temperature applications, including applications where the stir-welding process used to assemble the rotor generates substantial heat. In lower temperature applications, or applications where the heat generated by the stir-welding process is effectively removed through a cooling process, other coatings, such as polytetrafluoroethylene (PTFE), may be used.

In one assembly manner, the coating 110 may be applied to the conductor bar 26 before the bar 26 is inserted in the rotor stack 10. The coating material 110 may be applied, for example, by hot dipping, vapor depositing, or by any other suitable coating method. Alternatively, the coating may be applied to the rotor stack 10 as an initial manner, with the un-insulated conductor rod 26 then being inserted into the insulated slot 16.

While the best modes for carrying out the invention have been described in detail, those familiar with the art to which this invention relates will recognize various alternative designs and embodiments for practicing the invention within the scope of the appended claims. All directional references (e.g., upper, lower, upward, downward, left, right, leftward, rightward, above, below, vertical, and horizontal) are only used for identification purposes to aid the reader's understanding of the present invention, and do not create limitations, particularly as to the position, orientation, or use of the invention. It is intended that all matter contained in the above description or shown in the accompanying drawings shall be interpreted as illustrative only and not as limiting.

1. A stir-welded rotor comprising:
a stack of laminations, each of the laminations defining spaced-apart slots arrayed on an outer circumference;
a conductor bar disposed in each of the spaced-apart slots of the stack of laminations, each conductor bar including a first metal portion and a second metal portion, the first and second metal portions having substantially dissimilar material compositions; and
wherein the first metal portion and a second metal portion are substantially aligned along a radial axis of the stack of laminations; and wherein the first metal portion is disposed radially inward of the second metal portion.

2. The stir-welded rotor of claim 1, further comprising:
a first end ring comprising a first inner end ring and a first outer end ring;
a second end ring comprising a second inner end ring and a second outer end ring;
wherein each conductor bar has a first extremity engaging the first end ring between the first inner end ring and the first outer end ring and extending above the stack of laminations, and a second extremity engaging the second end ring between the second inner end ring and the second outer end ring and extending below the stack of laminations; and
a stir weld securing the first extremities of the respective conductor bars to the first inner end ring and the second outer end ring, and a stir weld securing the second extremities of the respective conductor bars to the second inner end ring and the second outer end ring.

3. The stir-welded rotor of claim 1, wherein each of the laminations includes a neck portion partially extending into each respective slot, the neck portion configured to contact the conductor bar and restrain the conductor bar from radially outward movement.

4. The stir-welded rotor of claim 1, wherein the lamination defines a first neck portion, a second neck portion that extend into each of the respective slots, the first neck portion configured to contact the first metal portion of the conductor bar and to restrain the first metal portion from radially outward movement, and the second neck portion configured to contact the second metal portion of the conductor bar and to restrain the second metal portion from radially outward movement.

5. The stir-welded rotor of claim 1, wherein the composition of the first metal portion includes copper, and the composition of the second metal portion includes aluminum.

6. The stir-welded rotor of claim 1, wherein the composition of the first metal portion includes aluminum, and the composition of the second metal portion includes copper.

7. The stir-welded rotor of claim 6, wherein the second metal portion has a generally circular cross-section.

8. The stir-welded rotor of claim 1, wherein the second metal portion is in contact with the first metal portion, and the second metal portion restrains the first metal portion from radially outward movement

9. The stir-welded rotor of claim 1, further comprising an insulating coating disposed between the laminations and the respective conductor bars, the insulating coating including a material that has a higher electrical resistivity than the conductor bar.

10. The stir-welded rotor of claim 1, wherein the first metal portion and a second metal portion are in electrical communication.

11. A lamination adapted to be arrayed in a stacked series of laminations forming an induction motor rotor stack, the lamination comprising:
a circular metal disk having a centrally disposed circular hole, the metal disk defining a series of spaced-apart slots arrayed on an outer circumference, each slot being adapted to receive a conductor bar; and
wherein the circular metal disk further defines a neck portion partially extending into each respective slot, the neck portion configured to contact the conductor bar and restrain the conductor bar from radially outward movement.

12. The lamination of claim 11, wherein the neck portion is a first neck portion, and wherein the circular metal disk includes a second neck portion partially extending into each respective slot, the second neck portion being disposed along the slot and between the first neck portion and the centrally disposed circular hole.

13. The lamination of claim 12, wherein the second neck portion is configured to contact the conductor bar and restrain the conductor bar from radially outward movement.

14. A stir-welded rotor comprising:
a stack of laminations, each of the laminations defining spaced-apart slots arrayed on an outer circumference, and including a neck portion partially extending into each respective slot;
a first end ring comprising a first inner end ring and a first outer end ring;
a second end ring comprising a second inner end ring and a second outer end ring;
a conductor bar registered with each of the spaced-apart slots of the stack of laminations, each conductor bar including a first metal portion and a second metal portion, the first and second metal portions having dissimilar compositions, the conductor bar having a first extremity engaging the first end ring between the first inner end ring and the first outer end ring and extending above the stack of laminations, and having a second extremity engaging the second end ring between the second inner end ring and the second outer end ring and extending below the stack of laminations; and
a first stir weld securing the first extremities of adjacent conductor bars to the first inner end ring and the second outer end ring, and a second stir weld securing the second extremities of adjacent conductor bars to the second inner end ring and the second outer end ring; and
wherein the neck portion extending into each respective slot is configured to contact the respectively registered conductor bar and to restrain the conductor bar from radially outward movement.

15. The stir-welded rotor of claim 14, wherein the first metal portion and a second metal portion are substantially aligned on a radial axis; and wherein the first metal portion is disposed radially inward of the second metal portion.

16. The stir-welded rotor of claim 15, wherein the second metal portion is in contact with the first metal portion, and the second metal portion restrains the first metal portion from radially outward movement

17. The stir-welded rotor of claim 14, further comprising an insulating coating disposed between the laminations and the conductor bar, the insulating coating including a material that has a higher electrical resistivity than the conductor bar.
